(19) United States
(12) Patent Application Publication
(10) Pub. No.: US 2020/0126121 A1
(43) Pub. Date: Apr. 23, 2020

(54) SURFACING ADVERTISEMENTS TO PURCHASE TANGIBLE PRODUCTS THROUGH DIGITAL TRANSACTIONS

(71) Applicant: GoSkip, Inc., South Jordan, UT (US)

(72) Inventors: Chase Vincent Thomason, South Jordan, UT (US); Wallace Eric Smith, Pleasant Grove, UT (US)

(21) Appl. No.: 16/660,587

(22) Filed: Oct. 22, 2019

Related U.S. Application Data
(60) Provisional application No. 62/749,558, filed on Oct. 23, 2018.

(51) Int. Cl. G06Q 30/02; G06Q 30/06

(52) U.S. Cl. CPC G06Q 30/0255; G06Q 30/0639; G06Q 30/0226; G06Q 30/0261

(57) ABSTRACT

An example method may include obtaining a digital advertisement for a tangible product, a location-based condition of the digital advertisement, an inventory-based condition of the digital advertisement, location information of a consumer, and inventory information of a physical location associated with a retailer. The method may also include estimating a future location of the consumer based on the location information. The method may also include determining to surface the digital advertisement at the client device in response to the estimated future location satisfying the location-based condition and/or the inventory information satisfying the inventory-based condition. The consumer may purchase the tangible product from a retailer. The consumer may pick up the tangible product from the physical location associated with the retailer.

### CROSS-REFERENCE TO RELATED APPLICATION

This application claims the benefit of and priority to U.S. Provisional Patent App. No. 62/749,558, filed Oct. 23, 2018. The 62/749,558 provisional application is incorporated herein by reference.

### FIELD

The embodiments discussed in the present disclosure are related to surfacing advertisements to purchase tangible products through digital transactions.

### BACKGROUND

Unless otherwise indicated herein, the materials described herein are not prior art to the claims in the present application and are not admitted to be prior art by inclusion in this section.

Many advertisements are produced and presented to generate interest in a product or to entice consumers to purchase the product. Some advertisements are presented to consumers that may be likely to purchase the product.

The subject matter described in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some embodiments described herein generally relate to surfacing advertisements to purchase tangible products through digital transactions.

In an example embodiment, a method may include obtaining a digital advertisement for a tangible product, a location-based condition of the digital advertisement, and location information of a consumer from a client device associated with the consumer. The method may also include estimating a future location of the consumer based on the location information. The method may also include determining to surface the digital advertisement at the client device in response to the estimated future location satisfying the location-based condition. The consumer may purchase the tangible product from a retailer through a digital financial transaction.

In some embodiments, the consumer may purchase the tangible product from the retailer remotely. For example, the consumer may purchase the tangible product online and/or when the consumer is not at the physical location associated with the retailer. The consumer may purchase the tangible product from the retailer in response to the digital advertisement. For example, the consumer may click on or otherwise select the digital advertisement to purchase the product in response to the digital advertisement being surfaced to the consumer. The consumer may pick up the tangible product from the physical location without performing a checkout process at the physical location since the consumer has already completed the digital financial transaction for the tangible product. Alternatively, the consumer may have the tangible product delivered from the physical location to the consumer by a delivery service such as POSTMATES, DOORDASH, or other suitable delivery service.

In another example embodiment, a method may include obtaining a digital advertisement for a tangible product, an inventory-based condition of the digital advertisement, and inventory information of a physical location associated with a retailer. The method may also include determining to surface the digital advertisement at a client device in response to the inventory information satisfying the inventory-based condition. The consumer may purchase the tangible product from a retailer through a digital financial transaction. The consumer may pick up the tangible product from a physical location associated with the retailer or have the tangible product delivered by a delivery service.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example environment to surface a digital advertisement to purchase a tangible product through digital transactions;

FIG. 2 is a flow chart of an example process to surface a digital advertisement to purchase a tangible product through digital transactions; and

FIG. 3 is a block diagram of an example computing system,

all arranged according to at least one embodiment described in the present disclosure.

### DESCRIPTION OF EMBODIMENTS

The present disclosure relates to surfacing advertisements to purchase tangible products through digital transactions.

An advertiser may produce a digital advertisement to generate interest in purchasing a tangible product. The advertiser may recognize that particular groups of consumers, and/or particular individuals, are more likely to purchase the tangible product than other consumers. The advertisers may seek to present the advertisement to the particular groups of consumers and/or particular individuals. The advertisers may present the advertisements to the consumers by surfacing advertisements to the consumers on electronic devices of the consumers, such as smart phones, laptop computers, or other electronic devices of the consumers.

In an example, systems and methods of the present disclosure may obtain a digital advertisement and advertisement conditions, e.g., from one or more retailers. The digital advertisement may be presented, e.g., surfaced to one or more consumers, based on and/or in response to the satisfaction of the advertisement conditions, e.g., by the one or more consumers, such that the digital advertisement may be presented to consumers that may be more likely to purchase the advertised product.

For example, the advertisement conditions may be based on a location of a consumer. In more detail, the digital advertisement may be presented to consumers within a threshold distance of a physical location associated with a retailer. Additionally or alternatively, systems and methods of the present disclosure may include estimating a future location of the consumer. The digital advertisement may be presented to the consumer based on the estimated future location satisfying the advertisement conditions. For example, if a consumer passes by a physical location associated with a retailer, such as a brick and mortar retail location of the retailer, multiple days at substantially the same time, an estimation may be made that the consumer will pass by the physical location at about the same time on an upcoming day. Based on the estimation, a digital advertisement may be surfaced to the consumer for a product that the consumer could purchase, e.g., digitally, and then pick up at the physical location. The digital advertisement may be surfaced at a predetermined time, for example, ten minutes before the same time on the upcoming day.

As another example, the advertisement conditions may be based on inventory information of a physical location associated with a retailer. For example, the digital advertisement may be presented to consumers when the physical location has a particular number of instances of the product available for purchase or when the physical location has the product available at a price that satisfies the advertisement condition.

Additionally or alternatively, a digital advertisement may include an offer to sell a product. A consumer may accept the offer by sending a purchase request, e.g., by clicking on or otherwise selecting the digital advertisement or otherwise sending the purchase request. The purchase request may be received, and a digital financial transaction may be completed between the consumer and a retailer. The digital financial transaction may be effective for the consumer to purchase the product from the retailer. The consumer may then pick up the product from the physical location associated with the retailer without performing a checkout process at the physical location, or may have the product delivered to the consumer by a delivery service. For example, after confirming a desire to purchase the tangible product, a request may be made to the consumer to select in-store pickup of the product or delivery of the product by the delivery service. If in-store pickup is selected, the digital financial transaction may be completed and the consumer may then travel to the physical location to pick up the product without performing a checkout process at the physical location since the digital financial transaction has already been completed. If delivery is selected, a total transaction amount including delivery fees, if any, may be updated, the digital financial transaction may be completed, the order information may be conveyed to the delivery service, and the delivery service may pickup the product from the physical location and deliver it to the consumer.

In an example, a consumer may be on a social media platform such as INSTAGRAM or other platform and may see the surfaced digital advertisement. Clicking on the digital advertisement may add a product identified in the digital advertisement to a digital shopping cart of the consumer, the order to be fulfilled by a given retailer. In some embodiments, the consumer may add additional products available from the retailer to the digital shopping cart. For example, the consumer may search for and then select one or more specific items available from the retailer and/or one or more available items may be presented to and selected by the consumer. Any additional item(s) selected by the consumer may be added to the digital shopping cart and the digital financial transaction for all selected items/products in the digital shopping cart may then be completed when the consumer is ready to digitally check out.

When the consumer does in-store pickup of a purchased product, one or more of the following actions may be taken prior to the consumer picking up the purchased product. First, a QR code may be provided to the consumer that may include, e.g., identification of the purchased product(s), confirmation of completion of the digital financial transaction, an amount of the digital financial transaction, identification of the consumer, and/or other information. Second, a sales clerk at the physical location of the retailer may be notified that the tangible product at the physical location has been purchased and will be picked up by the consumer. Third, an address of the physical location of the retailer and/or other identifying information of the physical location may be provided to the user. Fourth, rout navigation instructions from a current location of the consumer to the physical location of the retailer may be provided to the consumer. Fifth, the consumer may be notified of a specific aisle, department, or other specific area at the physical location where the tangible product may be located for pickup by the consumer.

When the consumer arrives at the physical location to pick up the product, the consumer may present the QR code (e.g., on a mobile device of the consumer) to a scanner at the physical location. The QR code may be scanned, e.g., to confirm to the clerk that the consumer has already paid for the product via the prior digital financial transaction such that the consumer can take the product and leave without performing a standard checkout process (e.g., standing in line, providing payment information to a point of sale, completing an in-person financial transaction, etc.) at the physical location.

Brand loyalty and/or participation in a loyalty program or promotion may be used as an input in determining whether to surface an advertisement. Accordingly, some embodiments described herein may track involvement of the consumer in a loyalty program or promotion. For instance, some retailers have loyalty promotions in which a consumer may receive a product free after purchasing multiple other instances of the product, e.g., buy 9 coffees get the 10^{th} coffee free. For convenience, the number of products that have to be purchased before receiving the free product may be referred to as N products. If the consumer has purchased N−1 products, the advertisement may be surfaced for the consumer to buy the Nth product so that the consumer can thereafter receive the N+1th product free.

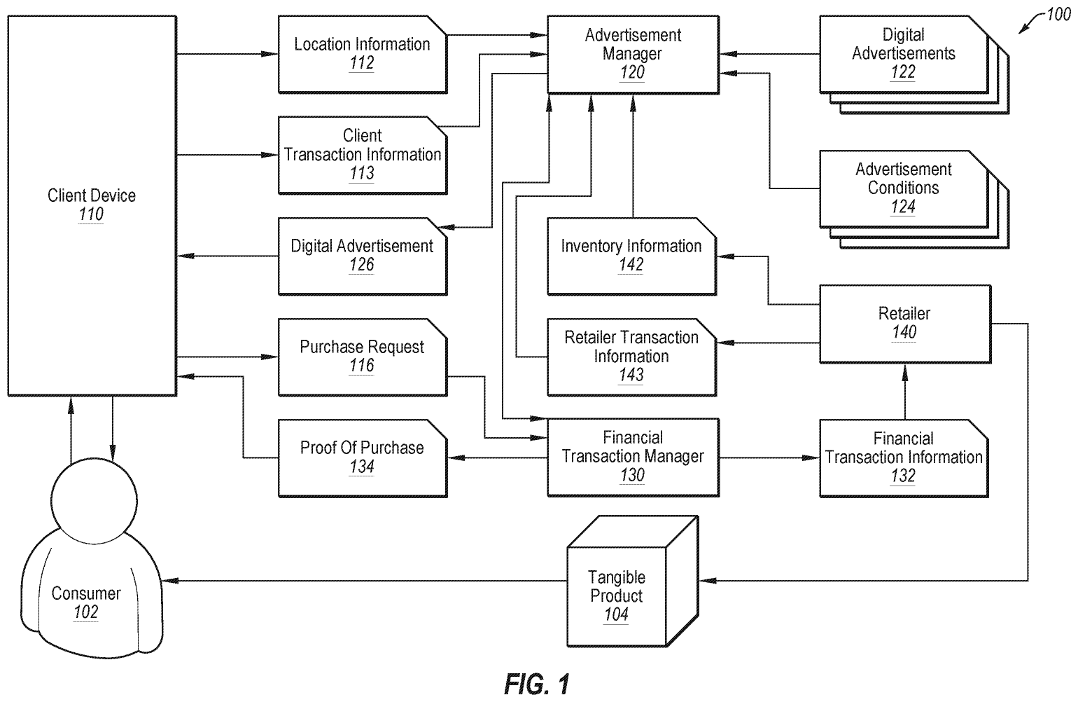

FIG. 1 is a block diagram of an example environment 100 to surface a digital advertisement 126 to purchase a tangible product 104 through digital transactions according to at least one embodiment described in the present disclosure. The environment 100 may include a client device 110, an advertisement manager 120, a financial transaction manager 130, and a retailer 140. The client device 110 may be associated with a consumer 102. Although a single consumer 102, client device 110, tangible product 104, and retailer 140 are depicted in FIG. 1, more generally, the environment 100 may include one or more tangible products 104, one or more retailers 140, and one or more consumers 102, each of the consumers 102 being associated with one or more client devices 110.

In some embodiments, in general, the advertisement manager 120 may obtain digital advertisements 122 and advertisement conditions 124. The advertisement manager 120 may obtain location information 112 from the client device 110 and/or inventory information 142 from the retailer 140. The advertisement manager 120 may determine, based on one or both of the location information 112 and the inventory information 142, that one or more of the advertisement conditions 124 is satisfied. Based on and/or in response to one or more of the advertisement conditions 124 being satisfied, one or more of the digital advertisements 122 may be selected to be surfaced to the client device 110 as illustrated by digital advertisement 126. The digital advertisement 126 may be surfaced at the client device 110 and may be viewed by the consumer 102. In some embodiments, the consumer 102, in response to viewing the digital advertisement 126, may determine to purchase the tangible product 104 that may be advertised in the digital advertisement 126. The consumer 102 may submit a purchase request 116 through the client device 110. The consumer submitting the purchase request 116 may include the consumer 102 clicking on or otherwise selecting the digital advertisement 126 surfaced on the client device 110 and/or otherwise providing input effective to indicate a desire to initiate a digital financial transaction to purchase the tangible product 104.

The financial transaction manager 130 may receive the purchase request 116 and complete the digital financial transaction between the consumer 102 and the retailer 140. The financial transaction manager 130 may transmit a financial transaction information 132 to the retailer 140 to notify the retailer 140 of the completed financial transaction. Additionally or alternatively, the financial transaction manager 130 may transmit a proof of purchase 134 to the consumer 102 to notify the consumer 102 of the completed financial transaction. The consumer 102 may pick up the tangible product 104 at a physical location of the retailer 140. The physical location of the retailer 140 may include one of potentially multiple brick and mortar retail locations of the retailer 140, for example.

In some embodiments, the consumer 102 may include a human. The consumer 102 may use the client device 110. The consumer 102 may have financial assets and may be capable of purchasing products through digital financial transactions. For example, the consumer 102 may possess a credit card, a debit card, a digital wallet, or other instrument that may allow the consumer 102 to pay for products digitally. The consumer 102 may further be capable of picking up the tangible product 104 from a physical location associated with the retailer 140.

In some embodiments, the tangible product 104 may include any tangible product, for example, a soft drink, a candy bar, a cup of coffee, a pizza, gasoline, a phone charger, socks, toys, tools, electronics, a book, or other tangible product. The tangible product 104 may be capable of being picked up at a physical location associated with the retailer 140.

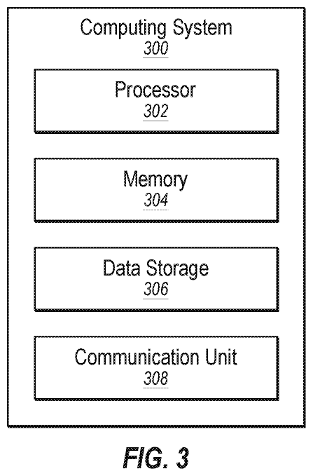

In some embodiments, the client device 110 may include an electronic device used by the consumer 102, for example a smart phone, a tablet, a personal computer, a smart speaker, a watch, an automotive smart display, or other electronic device. The client device 110 may include a computing system, for example, the computing system 300 of FIG. 3.

In some embodiments, the client device 110 may be configured to generate the location information 112, for example, the location information 112 may be generated by a mobile phone tracking system, a global positioning system (GPS) receiver, a mobile-phone-network-based location system, or other location system. Additionally or alternatively, the client device 110 may be configured with a stationary or home location. The client device 110 may be configured to transmit the location information 112 to the advertisement manager 120. For example, the client device 110 may include a communication module such as a long-term evolution (LTE) radio or other suitable communication module to transmit the location information 112 to the advertisement manager 120. The client device 110 may transmit the location information 112 through a computer network, for example, the Internet and/or through a cellular phone network.

In some embodiments, the location information 112 may include two or more locations of the client device 110 and two or more corresponding times. The locations may be in any suitable format, for example, latitude and longitude. The location information 112 may include a location history of the client device 110 including multiple locations polled at regular intervals. Additionally or alternatively, the location information 112 may include a current location of the client device 110 and/or that may be sent one or more times over time to a server and/or the cloud where the current locations over time may be used to generate a location history of the client device 110 at the server. Additionally or alternatively, the location information 112 may include locations obtained from other applications of the client device 110, for example, mapping applications, or calendar applications. The location information 112 may include estimated future locations, or locations, for example, based on a route entered into a mapping application or a calendar appointment. In the present disclosure, it is assumed that the consumer 102 is at the same location as the client device 110. Therefore, in the present disclosure, the references to the location of the consumer 102 are to be understood as equivalent to references to the location of the client device 110 and vice versa.

In some embodiments, the client device 110 may be configured to generate the client transaction information 113. For example, the client device 110 may store, or have access to information related to purchases of the consumer 102, e.g., purchases made using accounts on the client device 110. The client device 110 may be configured to transmit the client transaction information 113 to the advertisement manager 120. Alternatively or additionally, the client transaction information 113 may be generated at a server and/or the cloud by storing details of one or more digital financial transactions completed via the client device 110.

In some embodiments, the client transaction information 113 may include information regarding one or more purchases of the consumer 102. The client transaction information 113 may include information from one or more digital financial transactions that are completed and/or performed using the client device 110, for example, digital financial transactions using applications or programs of the client device 110. Additionally or alternatively, the client transaction information 113 may include information from one or more accounts of the consumer 102, including accounts accessed using the client device 110.

For example, the client transaction information 113 may include information from a digital wallet app, a bank account, a credit card, a retailer website, a retailer loyalty program, and/or from one or more other accounts of the consumer 102.

In some embodiments, the retailer 140 may include a vendor of tangible products, including the tangible product 104. The retailer 140 may be associated with one or more physical locations. The physical locations may have the tangible products available for sale. The retailer 140 may include a computing system, such as the computing system 300 of FIG. 3, that may be configured to perform one or more of the operations described herein. For example, the retailer 140 may generate the inventory information 142 which may include information related to tangible products available at one or more of the physical locations associated with the retailer. Additionally or alternatively, the retailer 140 may generate the retailer transaction information 143. In some embodiments, the retailer 140 may generate and/or provide the digital advertisements 122 and/or the advertisement conditions 124. Alternatively or additionally, a producer or other entity may generate the digital advertisements 122 and/or the advertisement conditions 124.

In some embodiments, the inventory information 142 may include information of the retailer 140 regarding one or more tangible products 104. The inventory information 142 may include information related to one or more physical locations of the retailer 140. For example, the inventory information 142 may include information regarding whether the tangible product 104 is available for sale at one or more physical locations of the retailer 140. The inventory information 142 may include information regarding a number of instances of the tangible product 104 that are currently available for sale at the physical location of the retailer 140. The inventory information 142 may include information regarding a sale price of the tangible product 104 at the physical location of the retailer 140, including information regarding any promotions or discounts that may apply to the tangible product 104.

In some embodiments, the retailer transaction information 143 may include information regarding one or more purchases of one or more consumers, including the consumer 102. For example, the retailer transaction information 143 may include all of the purchases made by the consumer 102 at the retailer 140, including purchases at different physical locations associated with the retailer 140.

In some embodiments, the digital advertisements 122 may include multiple digital advertisements produced with the intent of generating consumer interest in various products or brands and/or enticing consumers to purchase the various product. The digital advertisements 122 may include audio and/or visual aspects. The digital advertisements 122 may include offers for sale, e.g., offers for a consumer 102 to purchase one or more tangible products 104 advertised in the digital advertisements 122. In some embodiments, the digital advertisements 122 may specify a discounted price or other value (e.g., buy one get one free, buy one product get a different product free or at a discounted price, etc.) associated with purchase by the consumer 102 of the tangible product 104.

In some embodiments, a particular retailer 140 may generate, or have input into the generation of one or more of the digital advertisements 122. Thus, one or more of the digital advertisements 122 may relate to the particular retailer 140. Also, one or more of the digital advertisements 122 may relate to a particular physical location of the particular retailer 140. In these or other embodiments, one or more of the digital advertisements 122 may include a reference to the particular physical location. Additionally or alternatively, one or more of the digital advertisements 122 may relate to a particular product that is available at a physical location of the retailer 140. Additionally or alternatively, one or more of the digital advertisements 122 may relate to a particular price of the particular product or other value. In these or other embodiments, one or more of the digital advertisements 122 may include the particular price of the particular product or other value. For example, a particular digital advertisement 122 may include an advertisement for a particular product that is on sale at a particular physical location of a particular retailer at a particular price. The particular digital advertisements 122 may present to the consumer 102 each of the particular product, the particular physical location, the particular retailer, and the particular price or other value.

In some embodiments, the advertisement conditions 124 may include conditions corresponding to the digital advertisements 122. For example, each of the digital advertisements 122 may be associated with at least one advertisement condition 124. The advertisement conditions 124 may include rules or conditions for when to present the digital advertisements 122. The advertisement conditions 124 may include conditions on such things as a current location of a consumer 102, an estimated future location of a consumer 102, a price of a tangible product 104, the availability of a tangible product 104 at a physical location of a retailer 140, a sale price of a tangible product 104, and/or one or more other conditions.

As mentioned above, in some embodiments, the advertisement manager 120 may be configured to obtain the digital advertisements 122, the advertisement conditions 124, the location information 112, and the inventory information 142. The advertisement manager 120 may be configured to determine that one or more of the advertisement conditions 124 associated with a corresponding one, or potentially multiple ones, of the digital advertisements 122 is satisfied based on information of the location information 112 and/or the inventory information 142. Based on the satisfaction of the one or more of the advertisement conditions 124, the advertisement manager 120 may determine to surface the corresponding digital advertisement 126, from among the digital advertisements 122.

The advertisement conditions 124 may include a location-based condition. For example, a particular advertisement condition 124 may be satisfied when a consumer 102 is within ten miles (or other threshold distance) of a physical location of the retailer 140. In response to a client device 110 providing location information 112 that includes a current location of the client device 110 that is within ten miles of the physical location of the retailer 140, a digital advertisement 126 that corresponds to the particular advertisement condition 124 may be selected, e.g., by the advertisement manager 120, to surface to the client device 110 of the consumer 102.

As another example, the advertisement conditions 124 may include a location-based condition that can be satisfied by an estimated future location. For example, a particular advertisement condition 124 may be satisfied when a future location of the consumer 102 is estimated to be is within ten miles (or other threshold distance) of a physical location of the retailer 140. Based on the location information 112, a future location of the client device 110 may be estimated. In response to the estimated future location being within ten miles (or other threshold distance) of the physical location of the retailer 140, a digital advertisement 126 that corresponds to the particular advertisement condition 124 may be selected for surfacing to the client device 110 of the consumer 102.

Additionally or alternatively, an advertisement time may be determined. The advertisement time may be the time at which to surface the digital advertisement 126. The advertisement time may be based on the estimated future location and the particular advertising condition 124. For example, the advertisement time may correspond to the time corresponding to the estimated future location (e.g., the time at which the consumer 102 is estimated to be at the future location), and/or the time at which the estimated future location satisfies the particular advertising condition. The advertisement time may be selected, based on the advertisement condition 124, to be before the estimated future location satisfies the condition. For example, the advertisement time may correspond to a time before the consumer 102 leaves home, or a time ten minutes before the future location is estimated to satisfy the advertisement condition 124.

As an example of an estimated future location of a consumer 102 satisfying an advertising condition 124, the consumer 102 may commute to work using the same route every weekday at about the same time. The route to work may be stored in the location information 112. Based on the location information 112, one or more future locations of the consumer 102 may be estimated. The estimated future locations may include the route to work on upcoming weekdays. The estimated future locations may correspond to the same time of day on the upcoming weekdays. An advertising condition 124 may exist that can be satisfied by an estimated future location that is within, e.g., one hundred yards of a physical location between the hours of 6:00 AM and 9:00 AM on weekdays. Such an advertising condition 124 may be desirable for, e.g., a coffee shop, to advertise to commuters that may be close to the coffee shop. If the estimated future locations of the consumer 102 satisfy the advertising condition 124, a digital advertisement 126 corresponding to the advertising condition may be selected to surface at the client device 110. The advertisement time of the digital advertisement 126 may be selected such that the consumer 102 may see the digital advertisement 126 before the consumer 102 begins his morning commute, while the consumer 102 is en route but prior to arriving at the physical location, and/or at another suitable time, as determined from the location information 112. Additionally or alternatively, the advertisement time may be ten minutes before the estimated future location of the consumer 102 is within one hundred yards of the coffee shop. Additionally or alternatively, the consumer 102 may be provided with location information of the coffee shop, including directions on how to travel from the current location of the consumer 102 to the location of the coffee shop.

As another example of an estimated future location of a consumer 102 satisfying an advertisement condition 124, the consumer 102 may be travelling along a highway or other route on a road trip. The location information 112 of the consumer 102 may include locations that the consumer 102 has passed through along the highway. Estimated future locations of the consumer 102 may include locations along the highway that the consumer 102 may pass through as estimated based on the past location information 112. Additionally or alternatively, the location information 112 may include a route based on a mapping and/or navigation application. The estimated future location may be based on a location along the route, and/or a destination. An advertising condition 124 may exist that may be satisfied by an estimated future location that is within one mile of a physical location of a retailer 140. For example, a gas station along the highway may wish to advertise to any consumers 102 that may travel the highway. Based on the estimated future location of the consumer 102 satisfying the advertising condition 124, a digital advertisement 126 corresponding to the advertisement condition 124 may be selected to surface to the client device 110. The advertisement time may be selected such that the digital advertisement 126 is surfaced while the consumer 102 is, e.g., ten miles (or other threshold distance or estimated time) from the gas station. Additionally or alternatively, the consumer 102 may be provided with location information of the gas station, including directions on how to travel from a current location of the consumer 102 to the location of the gas station.

Additionally or alternatively, there may be multiple digital advertisements 122 with multiple tiered advertisement conditions 124. For example, the gas station may have a first digital advertisement 126 with a first advertisement condition 124 such that the first digital advertisement 126 is configured to be surfaced when the consumer 102 is fifty miles from the gas station, as estimated based on the location information 112. The gas station may have a second digital advertisement 126 with a second advertisement condition 124 such that the second digital advertisement 126 is configured to be surfaced when the consumer 102 is twenty miles from the gas station, as estimated based on the location information 112. The gas station may have a third digital advertisement 126 with a third advertisement condition 124 such that the third digital advertisement 126 is configured to be surfaced when the consumer 102 is one mile from the gas station, as estimated based on the location information 112. The third digital advertisement may include driving directions to get from the estimated location to the physical location, for example, “Take Exit 123 now.”

As another example of the operation of a location-based advertising condition 124, a retailer 140 associated with multiple physical locations may wish to advertise broadly while providing specific useful location information to consumers 102 that may be close to the physical locations. The retailer 140 may generate multiple digital advertisements 122 and each of the digital advertisements 122 may include a reference to a different physical location. Each of the digital advertisements 122 may correspond to a location-based advertisement condition 124 based on the physical location included in the digital advertisement 122. Based on the estimated future location of the consumer 102 satisfying one of the advertisement conditions 124 a corresponding digital advertisement 126 may be selected to surface on the client device 110.

Additionally or alternatively, the advertisement conditions 124 may include inventory-based conditions. For example, an inventory-based advertisement condition 124 may be satisfied when a physical location associated with the retailer 140 has the tangible product 104 available for purchase, or available at a particular price or discount.

As an example of the satisfaction of an inventory-based condition, a producer of a tangible product 104 may determine to advertise the tangible product 104 in connection with a physical location that has the tangible product 104 available for purchase. The producer may provide the digital advertisement 126 and the corresponding advertisement condition 124, e.g. to the advertisement manager 120. The advertisement manager 120 may obtain inventory information 142 from one or more physical locations, and based on the satisfaction of the advertisement condition 124 by a particular physical location, determine to surface the digital advertisement 126 in association with the particular physical location. For example, the advertisement conditions 124 may be such that the digital advertisement 126 is determined to be surfaced to consumers with a home ZIP code that is within a threshold proximity (e.g. distance) from any of the one or more physical locations that has a threshold number of instances of the tangible product 104 available for purchase. Additionally or alternatively, the advertisement condition may be related to a price of the tangible product 104. The digital advertisement 126 may be surfaced in association with one or more physical locations that satisfy a price threshold for the tangible product 104. For example, the digital advertisement 126 may be configured to include an address of a particular physical location that has the tangible product 104 available for a price that satisfies a threshold, e.g. below fifty dollars.

As another example of the satisfaction of an inventory-based condition, a retailer 140 may wish to advertise a tangible product 104 if the tangible product 104 is available at one or more physical locations associated with the retailer, or if the tangible product 104 is available for a price that satisfies a price threshold. The retailer 140 may provide the digital advertisement 126 and a corresponding advertisement condition 124. The digital advertisement 126 may be determined to be surfaced if there is a physical location with the tangible product 104 that satisfies the advertisement condition 124. Additionally or alternatively, the digital advertisement 126 may be surfaced in connection with a physical location that has the tangible product 104 that satisfies the advertisement condition 124.

In some embodiments, there may be multiple and/or associated advertisement conditions 124 for a single digital advertisement 126. For example, a single digital advertisement 126 may be associated with a location-based advertisement condition 124 and an inventory-based condition 124. For example, a digital advertisement 126 may be configured to be surfaced for consumers that are currently within ten miles of a physical location that has the tangible product 104 for a particular price. As another example, if an estimated future location of a consumer 102 is within a threshold proximity (e.g., distance) from multiple physical locations of a retailer 140, a digital advertisement 126 may be determined to be surfaced based on one or more of the closest physical location to the estimated future location consumer 102, the physical location with the most instances of the tangible product 104 available for purchase, and/or the physical location that has the lowest price for the tangible product 104.

In some embodiments, the digital advertisement 126 determined to be surfaced from among the digital advertisements 122 may be based on the client transaction information 113 and/or the retailer transaction information 143. For example, based on the client transaction information 113 and/or the retailer transaction information 143, a tangible product 104 or category of tangible product 104 may be selected. The digital advertisements 122 and/or a subset of satisfied advertisement conditions 124 may be compared with the selected tangible product 104 or category of tangible product 104. Based on a correlation between the selected tangible product 104 or category of tangible product 104 and the subset of satisfied advertisement conditions 124, the digital advertisement 126 may be selected for surfacing. For example, from the client transaction information 113 a purchasing pattern of the consumer 102 may be identified, e.g., it may be determined that the consumer 102 regularly purchases a certain candy bar. There may be an advertisement condition 124 that the certain candy bar is to be advertised to consumers within one mile of any physical location that has the certain candy bar in stock. The advertisement manager 120 may determine to surface the digital advertisement 126 associated with the advertisement condition 124 for the certain candy bar based on the determination that the consumer 102 regularly purchases the candy bar and the satisfaction of the inventory-based condition 124 by a physical location within one mile of the consumer 102. The advertisement manager 120 may determine to surface the digital advertisement 126 instead of surfacing one or more other digital advertisements 122 that also have satisfied conditions based on the determination that the consumer 102 regularly purchases the candy bar.

In some embodiments, following the determination to surface the digital advertisement 126, the digital advertisement 126 may be surfaced. Surfacing the digital advertisement 126 may include displaying images or videos of the digital advertisement 126, or playing audio of the digital advertisement 126. The digital advertisement 126 may be surfaced by the advertisement manager 120 or another service provider by providing the digital advertisement 122 to the client device 110 to be displayed and/or otherwise output on the client device 110. A digital service provider may surface the digital advertisement 126 after it has been determined to be surfaced by the advertisement manager 120.

Returning now to the description of elements of FIG. 1, the client device 110 may be configured to receive the digital advertisement 126, for example, through a computer or cellular phone network. The client device 110 may be configured to present the digital advertisement 126, for example, the client device 110 may include a screen and/or speakers which may display a visual digital advertisement and/or play an audio digital advertisement.

In some embodiments, the digital advertisement 126 may include an advertisement produced with the intent of generating consumer interest in a product or a brand and/or enticing consumers to purchase a product. The digital advertisement 126 may include audio and/or visual aspects. The digital advertisement 126 may include an offer for the consumer 102 to purchase the tangible product 104. The digital advertisement 126 may include a prompt through which the consumer 102 can accept the offer and agree to purchase the tangible product 104. For example, the digital advertisement 126 may include a button or link, which, if selected by the consumer 102, will act as an agreement to purchase the tangible product 104. The digital advertisement 126 may be for a particular tangible product 104. Additionally or alternatively, the digital advertisement 126 may be for a brand of products or for several tangible products 104.

In some embodiments, the client device 110 may be configured to receive an input from the consumer 102 confirming the intent of the consumer 102 to purchase the tangible product 104. For example, the client device 110 may include a touch screen and/or a microphone and the consumer 102 may provide touch input, speech input, or other suitable input to confirm the intent to purchase the tangible product 104. The client device 110 may be configured to generate and transmit the purchase request 116 to the financial transaction manager 130, e.g., in response to receiving input from the consumer 102 that indicates the desire of the consumer 102 to purchase the tangible product 104.

In some embodiments the purchase request 116 may include a confirmation of the intent of the consumer 102 to purchase the tangible product 104. The purchase request 116 may include data in any suitable format.

As mentioned above, in some embodiments, the financial transaction manager 130 may be configured to receive the purchase request 116 and complete a digital financial transaction between the consumer 102 and the retailer 140. The financial transaction manager 130 may facilitate the digital financial transaction through one or more financial institutions including banks or credit card services. Additionally or alternatively, the financial transaction manager 130 may transfer money directly from an account of the consumer 102 to an account of the retailer 140. The financial transaction manager 130 may be configured to send the financial transaction information 132 to the retailer 140 and the proof of purchase 134 to the client device 110.

In some embodiments the financial transaction information 132 may be effective to notify the retailer 140 of the digital financial transaction. The financial transaction information 132 may be in any suitable format, for example, an e-mail or Internet Protocol (IP) message. The financial transaction information 132 may include information regarding the tangible product 104 and/or the purchase price of the tangible product 104. Additionally or alternatively, the financial transaction information 132 may include information regarding the consumer 102, for example, a picture of the consumer 102 or a location of the consumer 102.

In some embodiments, the client device 110 may be configured to receive the proof of purchase 134. The client device 110 may be configured to present the proof of purchase 134 at the physical location associated with the retailer 140. For example, the client device 110 may include a display screen configured to display the proof of purchase 134 and/or a near-field communication (NFC) radio configured to transmit the proof of purchase 134.

In some embodiments, the proof of purchase 134 may include a confirmation of a financial transaction in any suitable format. For example, the proof of purchase 134 may be included in an e-mail, text message, or in-app communication.

In some embodiments, the advertisement manager 120 and the financial transaction manager 130 may cooperate or share information. For example, the advertisement manager 120 and the financial transaction manager 130 may run on the same computing system or exchange information.

In some embodiments, the advertisement manager 120 may determine to surface a digital advertisement 126 that may be associated with one or more physical locations of one or more different retailers. Based on the response of the consumer 102 to the digital advertisement 126, the advertisement manager 120 and/or the financial transaction manager 130 may determine with which of the physical locations and/or retailers to complete the digital financial transaction. For example, a soft drink producer may advertise a soft drink to the consumer 102. The consumer 102 may provide input in response to the digital advertisement 126 to purchase the soft drink. The advertisement manager 120 and/or the financial transaction manager 130 may determine, for example, based on the location information 112, with which physical location and/or which retailer to complete the digital financial transaction to complete the purchase of the consumer 102. The consumer 102 may then be notified at which physical location the consumer 102 can pick up the soft drink. Additionally or alternatively, the consumer 102 may be presented with multiple potential pick up locations from which the consumer 102 may choose. The financial transaction manager 130 may complete the digital financial transaction with a selected pick up location.

As an example of completing a digital financial transaction, a consumer 102 may be presented with a digital advertisement 126 on the client device 110. In response to the digital advertisement 126, the consumer 102 may select the digital advertisement 126 on the client device 110 and/or provide other input to purchase a tangible product 104 that may be advertised in the digital advertisement 126. The client device 110 may transmit the purchase request 116 to the financial transaction manager 130. The financial transaction manager 130 may complete the digital financial transaction including exchanging money from the consumer 102 to a corresponding retailer 140. The financial transaction manager 130 may transmit the financial transaction information 132 to the retailer 140 notifying the retailer 140 of the completed transaction.

In some embodiments, in response to the financial transaction information 132, the retailer 140 may notify one or more employees of the completed financial transaction, including the tangible product 104 purchased, the purchase price, and/or information regarding the consumer 102. Additionally or alternatively, the retailer 140 may make the tangible product 104 available for pickup, by, for example, relocating the tangible product 104 to a more accessible location or deactivating a security device of the tangible product 104.

In some embodiments, the financial transaction manager 130 may transmit the proof of purchase 134 to the consumer 102. The proof of purchase 134 may inform the consumer 102 where to pick up the tangible product 104 and/or any protocol of the retailer 140 in picking up the tangible product 104. For example, after completing the digital financial transaction, the consumer 102 may be able to grab the tangible product 104 off the shelf of the physical location of the retailer 140 walk out of the physical location without taking any further action i.e. the consumer 102 may not perform any checkout procedure. For another example, the retailer 140 may instruct the consumer 102 to present the proof of purchase 134, for example, through NFC or barcode scan, to a cashier or kiosk before the consumer 102 leaves the physical location with the tangible product 104.

Any and all of the communications described with reference to the environment 100, including the location information 112, the client transaction information 113, the purchase request 116, the digital advertisements 122, the advertisement conditions 124, the digital advertisement 126, the financial transaction information 132, the proof of purchase 134, the inventory information 142, and the retailer transaction information 143 may be through any suitable means of electronic communication for example, e-mail, text message, or Internet Protocol (IP).

In some embodiments the advertisement manager 120 and/or the financial transaction manager 130 may include code and routines configured to enable a computing system to perform one or more operations to determine to surface the digital advertisements 126 and/or complete a digital financial transaction. The computing system may include, e.g., the computing system 300 of FIG. 3. Additionally or alternatively, the advertisement manager and/or the financial transaction manager 130 may be implemented using hardware including a processor, a microprocessor (e.g., to perform or control performance of one or more operations), a field-programmable gate array (FPGA), and/or an application-specific integrated circuit (ASIC) such as the processor 302 of FIG. 3. In some other instances, the advertisement manager 120 and/or the financial transaction manager 130 may be implemented using a combination of hardware and software. In the present disclosure, operations described as being performed by the advertisement manager 120 and/or the financial transaction manager 130 may include operations that the advertisement manager 120 and/or the financial transaction manager 130 may direct a system to perform.

Modifications, additions, or omissions may be made to the environment 100 without departing from the scope of the present disclosure. For example, in some embodiments there may be no physical separation between the advertisement manager 120 and the financial transaction manager 130. For another example, one or both of the client transaction information 113 and the retailer transaction information 143 may be omitted. Further, the order of operations may vary according to different implementations.

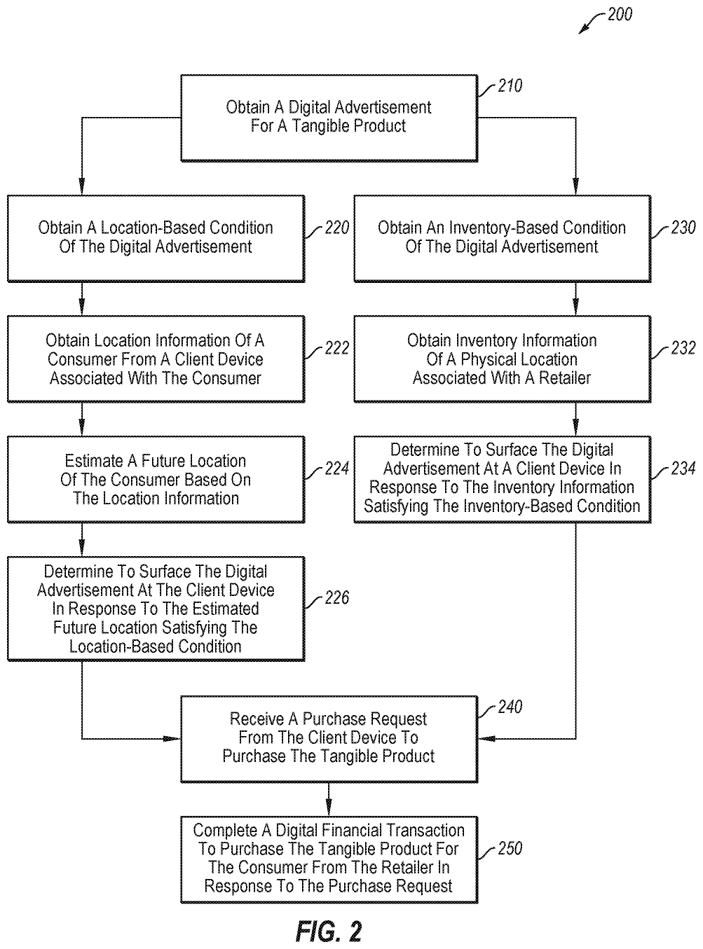

FIG. 2 is a flow chart of an example method 200 to surface a digital advertisement to purchase a tangible product through digital transactions, according to at least one embodiment described in the present disclosure. In some embodiments, one or more of the operations associated with the method 200 may be performed by elements of the environment 100 of FIG. 1. The method 200 may be performed by any suitable system, apparatus, or device. For example, the computing system 300 of FIG. 3 may perform or control performance of one or more of the operations associated with the method 200. Although illustrated with discrete blocks, the steps and operations associated with one or more of the blocks of the method 200 may be divided into additional blocks, combined into fewer blocks, or eliminated, depending on the desired implementation. The method 200 may begin at a block 210.

At the block 210, a digital advertisement for a tangible product may be obtained. The digital advertisement may include any of the digital advertisements 122 of FIG. 1. The tangible product may include the tangible product 104 of FIG. 1. The block 210 may be followed by either or both of a block 220 and a block 230.

At the block 220, a location-based condition of the digital advertisement may be obtained. The location-based condition may be and/or may be included in an advertisement condition, such as any of the advertisement conditions 124 of FIG. 1. The location-based condition may be associated with the digital advertisement of the block 210. The block 220 may be followed by a block 222.

At the block 222, location information of a consumer may be obtained from a client device associated with the consumer. The location information obtained at the block 222 may include the location information 112 of FIG. 1. The consumer may be the consumer 102 of FIG. 1. The client device may include the client device 110 of FIG. 1. The block 222 may be followed by a block 224.

At the block 224, a future location of the consumer may be estimated based on the location information. The estimated future location may correspond to a location in the location information. For example, the estimated future location may be a location where the consumer has been previously and to which the consumer may return, such as a location that is part of a daily commute of the consumer. Additionally or alternatively the estimated future location may be based on a route between locations in the location information. For example, the location information may include a starting location, a destination location, and/or a suggested navigation route between the starting and destination locations from a navigating application. The estimated future location may be the destination location or any point on and/or near (e.g., within a threshold distance from) the suggested navigation. As another example, the location information may include multiple points at which the consumer has been that are along a route to a destination, such as two points along a highway. The estimated future location may be an estimated destination or an estimated point further along the highway. The block 224 may be followed by a block 226.

At the block 226, a determination may be made to surface the digital advertisement at the client device in response to the estimated future location satisfying the location-based condition. After the determination is made at the block 226 to surface the digital advertisement, the digital advertisement may be surfaced at the client device, e.g., by providing the digital advertisement to the client device for the client device to output to the consumer. The client device may output the digital advertisement to the consumer in response to receiving the digital advertisement, e.g., from the advertisement manager 120 of FIG. 1. The block 226 may be followed by a block 240.

At the block 230, which may be preceded by the block 210, an inventory-based condition of the digital advertisement may be obtained. The location-based condition may be and/or may be included in an advertisement condition, such as any of the advertisement conditions 124 of FIG. 1. The inventory-based condition may be associated with the digital advertisement of the block 210. The block 230 may be followed by a block 232.

At the block 232, inventory information of a physical location associated with a retailer may be obtained. The inventory information may include the inventory information 142 of FIG. 1. The block 232 may be followed by the block 234.

At the block 234, a determination may be made to surface the digital advertisement at a client device in response to the inventory information satisfying the inventory-based condition. After the determination is made at the block 234 to surface the digital advertisement, the digital advertisement may be surfaced at the client device, e.g., by providing the digital advertisement to the client device for the client device to output to the consumer. The client device may output the digital advertisement to the consumer in response to receiving the digital advertisement, e.g., from the advertisement manager 120 of FIG. 1. The block 234 may be followed by a block 240.

The method 200 has been described as surfacing the digital advertisement to the client device in response to the estimated future location satisfying the location-based condition (at the block 226) or in the alternative as surfacing the digital advertisement at the client device in response to the inventory information satisfying the inventory-based condition (at the block 234). In some embodiments, the determinations at blocks 226 and 234 may instead be combined. For example, the blocks 226 and 234 may be combined into a single determination to surface the digital advertisement at the client device in response to both the estimated future location satisfying the location-based condition and the inventory information satisfying the inventory-based condition 234. Thus, embodiments described herein contemplate surfacing digital advertisements in response to satisfying a location-based condition, or in response to satisfying an inventory-based condition, or in response to satisfying both a location-based condition and an inventory-based condition.

At the block 240, which may be preceded by the block 226, the block 234, or a combined determination block as just described, a purchase request may be received from the client device. The purchase request may be effective to purchase the tangible product. In some embodiments, the purchase request may be generated at the client device by input provided at the client device by the consumer in response to the digital advertisement being surfaced at the client device. The purchase request may include the purchase request 116 of FIG. 1. The block 240 may be followed by a block 250.

At the block 250, a digital financial transaction may be completed. The digital financial transaction may be effective to purchase the tangible product for the consumer from the retailer. The digital financial transaction may be executed and completed in response to the purchase request.

Modifications, additions, or omissions may be made to the method 200 without departing from the scope of the present disclosure. For example, the method 200 may include one or the other or both of blocks 220, 222, 224 and 226 and blocks 230, 232, and 234. Further, the order of operations may vary according to different implementations.

One skilled in the art will appreciate that, for the environment 100, the method 200 and other processes and methods disclosed herein, the functions performed in the processes and methods may be implemented in differing order. Furthermore, the outlined steps and actions are only provided as examples, and some of the steps and actions may be optional, combined into fewer steps and actions, or expanded into additional steps and actions without detracting from the essence of the disclosed embodiments.

For example, following the block 250, the consumer may receive a notification of the completed financial transaction, such as a proof of purchase. The retailer may receive a notification of the completed digital financial transaction. The consumer may pick up the tangible product from a physical location of the retailer. In this and other embodiments, the consumer may pick up the tangible product from the physical location associated with the retailer without performing a checkout process at the physical location.

FIG. 3 is a block diagram of an example computing system 300, arranged according to at least one embodiment described in the present disclosure. As illustrated in FIG. 3, the computing system 300 may include a processor 302, a memory 304, a data storage 306, and a communication unit 308.

Generally, the processor 302 may include any suitable special-purpose or general-purpose computer, computing entity, or processing device including various computer hardware or software modules and may be configured to execute instructions stored on any applicable computer-readable storage media. For example, the processor 302 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, it is understood that the processor 302 may include any number of processors distributed across any number of network or physical locations that are configured to perform individually or collectively any number of operations described herein. In some embodiments, the processor 302 may interpret and/or execute program instructions and/or process data stored in the memory 304, the data storage 306, or the memory 304 and the data storage 306. In some embodiments, the processor 302 may fetch program instructions from the data storage 306 and load the program instructions in the memory 304. After the program instructions are loaded into the memory 304, the processor 302 may execute the program instructions, such as instructions to perform one or more operations described with respect to the client device 110 of FIG. 1, the advertisement manager 120 of FIG. 1, the financial transaction manager 130 of FIG. 1, the retailer 140 of FIG. 1, and/or the method 200 of FIG. 2.

The memory 304 and the data storage 306 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 302. By way of example, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 302 to perform a certain operation or group of operations. In these and other embodiments, the term “non-transitory” as explained herein should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 308 may be configured to receive messages, for example, the location information 112, the client transaction information 113, the purchase request 116, the digital advertisements 122, the advertisement conditions 124, the digital advertisement 126, the retailer transaction information 143, the financial transaction information 132, and the proof of purchase 134 of FIG. 1 and to provide the messages to the data storage 306. The communication unit 308 may include any device, system, component, or collection of components configured to allow or facilitate communication between the computing system 300 and a network. For example, the communication unit 308 may include a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. The communication unit 308 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to the computing system 300 without departing from the scope of the present disclosure. For example, the data storage 306 may be located in multiple locations and accessed by the processor 302 through a network.

As used herein, the advertisement manager 120 and the financial transaction manager 130 of FIG. 1 may refer to hardware implementations configured to perform the operations of the advertisement manager 120 and the financial transaction manager 130 and/or software objects or software routines that may be stored on and/or executed by general-purpose hardware (e.g., computer-readable media, processing devices, etc.) of the computing system 300. In some embodiments, the different components, modules, engines, and services described herein may be implemented as objects or processes that execute on the computing system 300 (e.g., as separate threads).

While some of the system and methods described herein are generally described as being implemented in software (stored on and/or executed by general-purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” Additionally, use of the term “and/or” in some places does not mean that the term “or” should be understood to only include either of the terms as opposed to including the possibility of both terms.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining a digital advertisement for a tangible product;
obtaining a location-based condition of the digital advertisement;
obtaining location information of a consumer from a client device associated with the consumer;
estimating a future location of the consumer based on the location information; and
determining to surface the digital advertisement at the client device in response to the estimated future location satisfying the location-based condition;
wherein the consumer purchases the tangible product from a retailer through a digital financial transaction and wherein the consumer picks up the tangible product from a physical location associated with the retailer.

2. The method of claim 1, wherein the location information includes two or more locations and two or more times corresponding to the two or more locations, wherein estimating the future location comprises estimating the future location based on the two or more locations, and wherein the method further comprises determining an advertisement time at which to surface the digital advertisement based on the two or more times, the estimated future location, and the location-based condition.

3. The method of claim 2, wherein two locations of the two or more locations are the same location, wherein two times of the two or more times are the same time of day on a first day and a second day, wherein the estimated future location is the same location, and wherein the advertisement time is the same time of day on a third day.

4. The method of claim 2, wherein both the estimated future location and the advertisement time are based on a route between a first location of the two or more locations and a second location of the two or more locations.

5. The method of claim 1, wherein the location-based condition is satisfied when the estimated future location is within a threshold proximity of the physical location.

6. The method of claim 1, further comprising:
selecting the physical location from among a plurality of physical locations associated with the retailer based on a proximity between the estimated future location and each of the plurality of physical locations; and
providing location information of the physical location to the client device.

7. The method of claim 1, further comprising:
receiving a purchase request from the client device to purchase the tangible product; and
completing a digital financial transaction to purchase the tangible product for the consumer from a retailer in response to the purchase request;
wherein the consumer picks up the tangible product without performing a checkout process at the physical location.

8. The method of claim 7, further comprising, in response to completing the digital financial transaction:
providing a proof of purchase to the client device, wherein the consumer provides the proof of purchase at the physical location when the consumer picks up the tangible product; and
notifying an employee at the physical location of the digital financial transaction, including notifying the employee of the tangible product purchased by the consumer.

9. The method of claim 1, further comprising obtaining inventory information of the physical location, the inventory information including an indication that the tangible product is available at the physical location, wherein determining to surface the digital advertisement is further based on the indication that the tangible product is available for pick up at the physical location.

10. The method of claim 1, further comprising obtaining a transaction history of the consumer, wherein:
obtaining the digital advertisement comprises obtaining a plurality of digital advertisements for a corresponding plurality of tangible products; and
determining to surface the digital advertisement comprises determining to surface the digital advertisement from among the plurality of digital advertisements based on a relationship between the tangible product and one or more transactions in the transaction history.

11. A method comprising:
obtaining a digital advertisement for a tangible product;
obtaining an inventory-based condition of the digital advertisement;
obtaining inventory information of a physical location associated with a retailer; and
determining to surface the digital advertisement at a client device of a consumer in response to the inventory information satisfying the inventory-based condition;
wherein the consumer purchases the tangible product from the retailer through a digital financial transaction.

12. The method of claim 11, wherein the inventory information includes an indication of whether the tangible product is available at the physical location and the inventory-based condition is satisfied when the tangible product is available at the physical location.

13. The method of claim 11, wherein the inventory information includes an indication of a number of instances of the tangible product available at the physical location and the inventory-based condition is satisfied when there are a threshold number of instances of the tangible product available at the physical location.

14. The method of claim 11 wherein the inventory information includes a price of the tangible product at the physical location and the inventory-based condition is satisfied when the price of the tangible product satisfies a price threshold.

15. The method of claim 11, further comprising obtaining a transaction history of the consumer, wherein:
obtaining the digital advertisement comprises obtaining a plurality of digital advertisements for a corresponding plurality of tangible products; and
determining to surface the digital advertisement comprises determining to surface the digital advertisement from among the plurality of digital advertisements based on a relationship between the tangible product and one or more transactions in the transaction history.

16. The method of claim 11, further comprising:
obtaining a location of the consumer; and
selecting the physical location from among a plurality of physical locations associated with the retailer based on a proximity between the consumer and each of the plurality of physical locations;
wherein obtaining the inventory information of the physical location is in response to selecting the physical location.

17. The method of claim 11, further comprising:
receiving a purchase request from the client device to purchase the tangible product; and
completing a digital financial transaction to purchase the tangible product for the consumer from the retailer in response to the purchase request;
wherein the consumer picks up the tangible product without performing a checkout process at the physical location.

18. The method of claim 17, further comprising, in response to completing the digital financial transaction:
providing a proof of purchase to the client device, wherein the consumer provides the proof of purchase at the physical location when the consumer picks up the tangible product; and
notifying an employee at the physical location of the digital financial transaction, including notifying the employee of the tangible product purchased by the consumer.

19. The method of claim 11, further comprising requesting from the consumer a selection of one of: in-store pickup of the tangible product by the consumer or delivery of the tangible product to the consumer by a delivery service, wherein:
in response to the consumer selecting in-store pickup, the consumer picks up the tangible product from the physical location without performing a checkout process at the physical location; and
in response to the consumer selecting delivery, the delivery service delivers the tangible product from the physical location to the consumer.

20. The method of claim 11, wherein:
the consumer picks up the tangible product from the physical location without performing a checkout process at the physical location; and
the method further comprises, prior to the consumer picking up the tangible product, at least one of:
notifying a sales clerk at the physical location that the tangible product at the physical location has been purchased and will be picked up by the consumer;
notifying the consumer of the physical location;
providing the consumer route navigation instructions from a current location of the consumer to the physical location; and
notifying the consumer of a specific aisle, department, or other specific area at the physical location where the tangible product is located for pickup.

21. The method of claim 11, further comprising:
surfacing the digital advertisement at the client device to the consumer;
receiving first input from the consumer to purchase the tangible product in response to surfacing the digital advertisement; and
receiving second input from the consumer to purchase a second tangible product from the retailer;
wherein the consumer purchases both the tangible product and the second tangible product from the retailer through the digital financial transaction.

22. The method of claim 21, further comprising at least one of:
after receiving the first input from the consumer to purchase the tangible product, asking the consumer whether the consumer would like to purchase one or more additional tangible products from a list of tangible products in addition to the tangible product; and
after receiving the first input from the consumer to purchase the tangible product and before receiving the second input from the consumer to purchase the second tangible product, receiving third input from the consumer requesting the second tangible product from the retailer.

23. The method of claim 11, further comprising tracking involvement of the consumer in a loyalty program or promotion, wherein determining to surface the digital advertisement is based on the involvement of the consumer in the loyalty program or promotion.
